(19) United States
(12) Patent Application Publication
(10) Pub. No.: US 2016/0042202 A1
(43) Pub. Date: Feb. 11, 2016

(54) Secure Shell for Electronic Devices

(71) Applicants: Kenneth Murray, Davis, CA (US); Deborah Peppers, Houston, TX (US); James Aikins, Modesto, CA (US); Michael T. Adams, San Carlos, CA (US)

(72) Inventors: Kenneth Murray, Davis, CA (US); Deborah Peppers, Houston, TX (US); James Aikins, Modesto, CA (US); Michael T. Adams, San Carlos, CA (US)

(21) Appl. No.: 14/821,660

(22) Filed: Aug. 7, 2015

Related U.S. Application Data
(60) Provisional application No. 62/034,719, filed on Aug. 7, 2014.

(51) Int. Cl. G06F 21/88; H02J 7/02; A45C 13/10; H05K 9/00; A45C 11/00; G06F 21/86; H05K 7/20

(52) U.S. Cl. CPC G06F 21/88; G06F 21/86; H02J 7/025; H05K 7/2039; H05K 9/0007; A45C 11/00; A45C 13/10; A45C 2011/002; A45C 2200/10

(57) ABSTRACT

An apparatus serving as a portable, lockable secure shell that prevents unauthorized physical and electrical signal access to a device enclosed within the shell. The apparatus comprises a case, a lid, a locking mechanism, cooling means, and charging means. When closed, the apparatus provides Faraday cage protection to an enclosed device to block external electronic, electromagnetic, and radio frequency signals from reaching the enclosed device, which preserves data stored in the device in its original form. In addition, the apparatus prevents clandestine access to an electronic device, which creates an obstacle to unauthorized access of information stored on the device.

### CROSS REFERENCE TO RELATED APPLICATIONS

This application claims the benefit of U.S. Provisional Application No. 62/034,719, filed Aug. 7, 2014.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD OF THE INVENTION

The present invention relates to security systems for portable electronic devices. More particularly, the present invention relates to prevention of unauthorized physical and electrical access to portable communication devices such as cell phones and tablets.

### BACKGROUND

Recent discoveries relating to the scope of electronic surveillance by the National Security Agency have given rise to growing concern for privacy especially in communication via personal electronics. Many people believe that technologies exist to enable remote activation of a cell phone without the user's knowledge or permission. As a result, an unauthorized party might intercept data streams or gain access to private and personal data stored on the phone. These concerns raise issues surrounding each individual's right to privacy and potential violation of the Fourth Amendment dealing with search and seizure. In particular, there have been several recent investigations into the use of a controversial electronic surveillance device, generally known as a STINGRAY. The STINGRAY is used for remotely capturing data from mobile telephones. It mimics a cell tower so all mobile phones in the area communicate with it and provide information, including location data. Purportedly, the STINGRAY is capable of obtaining this data even when the mobile phone is not being used to make a call.

In addition to public concerns, the judicial system, law enforcement and various government agencies, including the U.S. Department of Homeland Security, would benefit from an apparatus capable of enabling secure transportation of a cell phone for maintenance of forensic evidence. For example, if a police officer seizes a cell phone during a traffic stop or other action, it is in the interest of the judicial system to prevent data alteration or deletion from the cell phone. If the cell phone is not segregated from cell phone communications signals, the owner of the cell phone can remotely lock or remotely delete data from the cell phone. To lock a cell phone, delete data, alter data or wipe data, a user causes a command to be sent to the cell phone from another connected device or computer.

Law enforcement must deal with ensuring that proper procedures are followed whenever acquiring any evidence, including cell phones, which can have large amounts of data stored on the phone. Clearly, a law enforcement officer is motivated to ensure that he or she is not accused of improper handling or tampering of a seized cell phone. Likewise, law enforcement's forensic examiners prefer that a seized cell phone be delivered in its original state. Hence, such examiners would benefit from a solution to mitigate data deletion, tampering, and corruption while a cell phone is in custody of law enforcement.

Consequently, a need exists for an apparatus to secure electronic devices to both maintain a device's original state and to prevent data deletion, tampering, or corruption, particularly when the device has been acquired or seized during the course of a law enforcement or other government action.

### BRIEF SUMMARY

In view of the foregoing described needs, an embodiment of the present invention is an apparatus comprising a portable, lockable enclosure that prevents physical and electrical signal access to an electronic device, such as a cell phone. Although illustrated herein as providing physical and electronic security of a typical cell phone, such as an iPhone, the apparatus is scalable to accommodate other electronic devices, including laptops, tablets, hard drives, Global Positioning System (GPS) location devices, and music players, among others. For simplicity and clarity, we herein refer to the above-described types of devices as simply “electronic devices” or “devices”.

The apparatus, hereinafter a secure shell, comprises a case and lid which, when closed, serves as a physical enclosure and Faraday cage to prevent both physical and electronic signal access to a device. In various embodiments, the secure shell includes other features to support cooling and charging of an enclosed device.

When a communication device such as a cell phone is radio-isolated, the device will consume battery life more quickly while repeatedly attempting to acquire a signal. In a second embodiment, the apparatus includes means for charging a device to ensure that the device maintain its original power and data state without compromising Faraday cage protection. Means for charging include an inductive charging mat, a separate power connector deployed within the case, and a supplemental battery incorporated as a module within the case. Where a power cord is required, Faraday cage protection is maintained by use of a signal-resistant port. The signal-resistant port is configured such that electrical power is transmitted internally but external electromagnetic and radio frequency signals are blocked from reaching the antenna of the enclosed device. Either a power outlet or an external battery may be used to provide power to the device from an external source.

In another version, means for dissipating heat is provided as a feature of the apparatus. Heat dissipation ensures that the temperature of an enclosed device is maintained in a desired operational range. Heat may be generated either via the device itself, or, for example, by leaving the secure shell with the device in a hot environment such as the interior of a car. Heat dissipation is important to avoid higher temperatures that might cause the device to be permanently damaged or data on the device to be corrupted.

In one configuration, heat dissipation is provided via heat conductive heat transfer from the interior of the case to a heat sink, where the heat is radiated out of the interior of the case. In another configuration, heat dissipation occurs via the use of a phase change pad located in the interior of the case or adjacent the exterior of the case. The phase change pad reduces temperature by conversion of a solid cooling material in the pad to a gel or liquid. In another configuration, the phase change pad and heat sink may be used cooperatively to dissipate heat.

For physical security, the case includes a lock. In one configuration, the lock is a combination lock. Additionally, other access barriers, such as biometric identification, e.g., a fingerprint, may be incorporated as a requirement for unlocking and opening the shell.

### BRIEF DESCRIPTION OF THE SEVERAL VIEWS OF THE DRAWINGS

These and other features, aspects and advantages of various embodiments of the present invention will become better understood with regard to the following description, appended claims, and accompanying drawings where:

FIG. 1 is a perspective view of a first embodiment of the apparatus holding a cell phone with the lid open, according the invention;

FIG. 2 is a perspective view of the apparatus of FIG. 1 in a closed state;

FIG. 3A is a top plan view of the apparatus of FIG. 1 in a closed state;

FIG. 3B is a front elevation view of the apparatus of FIG. 1 in a closed state;

FIG. 3C is a bottom plan view of the apparatus of FIG. 1 in a closed state;

FIG. 3D is a rear elevation view of the apparatus of FIG. 1 in a closed state;

FIG. 4 is a bottom perspective view of the apparatus of FIG. 1;

FIG. 5 is an exploded view of major elements of the apparatus of FIG. 1;

FIG. 6 is a perspective view of a second embodiment of the apparatus in a closed state;

FIG. 7 is a perspective view of the second embodiment of the apparatus of FIG. 6 with the lid removed;

FIG. 8 is a perspective view of the second embodiment with the device removed to illustrate the power connector and cooling means;

FIG. 9 is a cross-section view of the apparatus of FIG. 6, taken along cutting plane A-A;

FIG. 10 is a perspective view of the case of FIG. 6 utilizing a phase change pad for cooling; and

FIG. 11 is a perspective view of the case of FIG. 6 utilizing conductive heat transfer cooling.

### OBJECTS OF THE INVENTION

One object is to provide a physical security system for portable communication devices such as cell phones, smart phones, and other handheld or portable data devices.

Another object is to provide a secure enclosure to prevent electronic tampering with a device caused by application of an external electrical field or signal.

Another object is to provide a secure enclosure having an integral charging system to allow a device to maintain its original state while in the enclosure.

Another object is to provide a secure enclosure that prevents overheating of a device while the device is within the enclosure.

Another object is to provide a secure enclosure having an environmental barrier and internal cushioning to minimize damage to a device enclosed in the case while in transit or exposed to the environment.

### DETAILED DESCRIPTION OF THE INVENTION

The following description is merely exemplary in nature and is in no way intended to limit the invention, its application, or its uses. Before the inventive subject matter is described in further detail, it is to be understood that the invention is not limited to the particular aspects described, as such may, of course, vary. It is also to be understood that the terminology used herein is for describing particular aspects only, and is not intended to be limiting, since the scope of the present invention will be limited only by the appended claims.

Unless defined otherwise, all technical and scientific terms used herein have the same meaning as commonly understood by one of ordinary skill in the art to which this inventive subject matter belongs. Although any methods and materials similar or equivalent to those described herein can also be used in the practice or testing of the inventive subject matter, a limited number of the exemplary methods and materials are described herein.

It must be noted that as used herein and in the appended claims, the singular forms “a,” “an,” and “the” include plural referents unless the context clearly dictates otherwise.

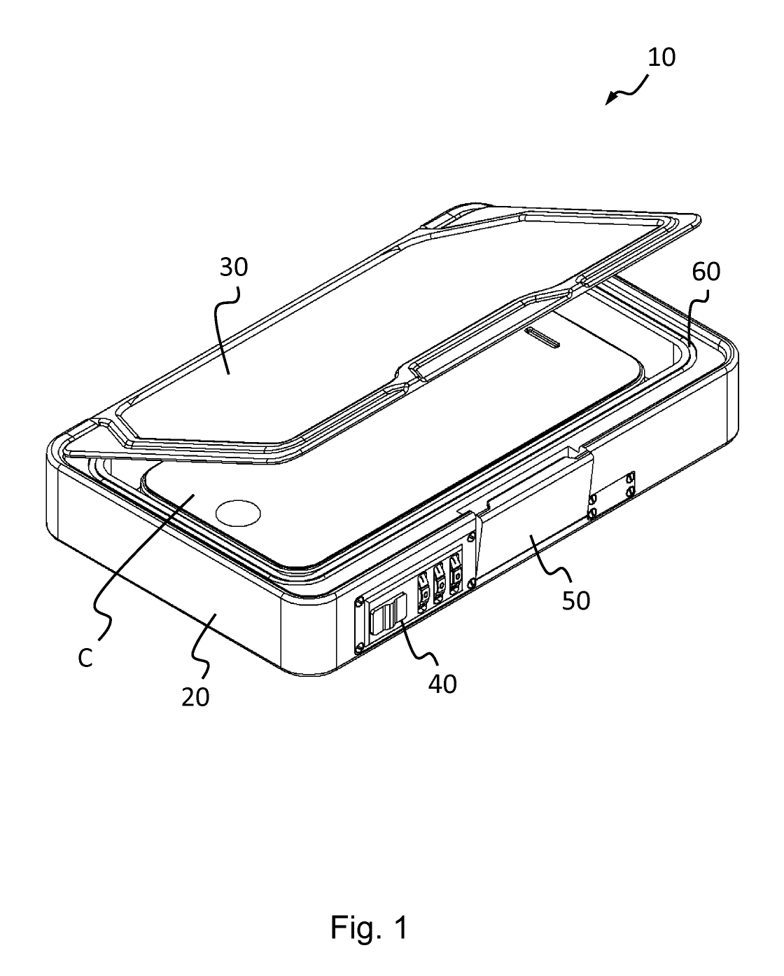

FIG. 1 provides a perspective view of the apparatus according to a first embodiment of the invention. The apparatus constitutes a secure shell 10 comprised of a case 20 and lid 30. The secure shell 10 further includes a locking mechanism 40 and latch 50 to fasten and lock the lid 30 in a closed position. The case 20 further includes a sealing O-ring 60 to create a sealed interface between the lid 30 and case 20. The case 20 is sized to receive a device C.

The case 20 in combination with lid 30 provides a complete Faraday cage and physical barrier to prevent physical and wireless signal access to the device C when the lid 30 of the shell 10 is closed. The case 20 and lid 30 of the shell 10 are sized to enclose an entire device C.

In use, the device C sits inside the shell 10. For exemplary purposes, the invention described herein is shown as housing an APPLE IPHONE, a well-known cell phone. However, the secure shell 10 is scalable in size and adaptable in shape to support any phone capable of wireless communication. In addition, the secure shell 10 may be adapted to house any electronic device capable of wireless communication, such as a tablet computer, GPS device, or laptop computer.

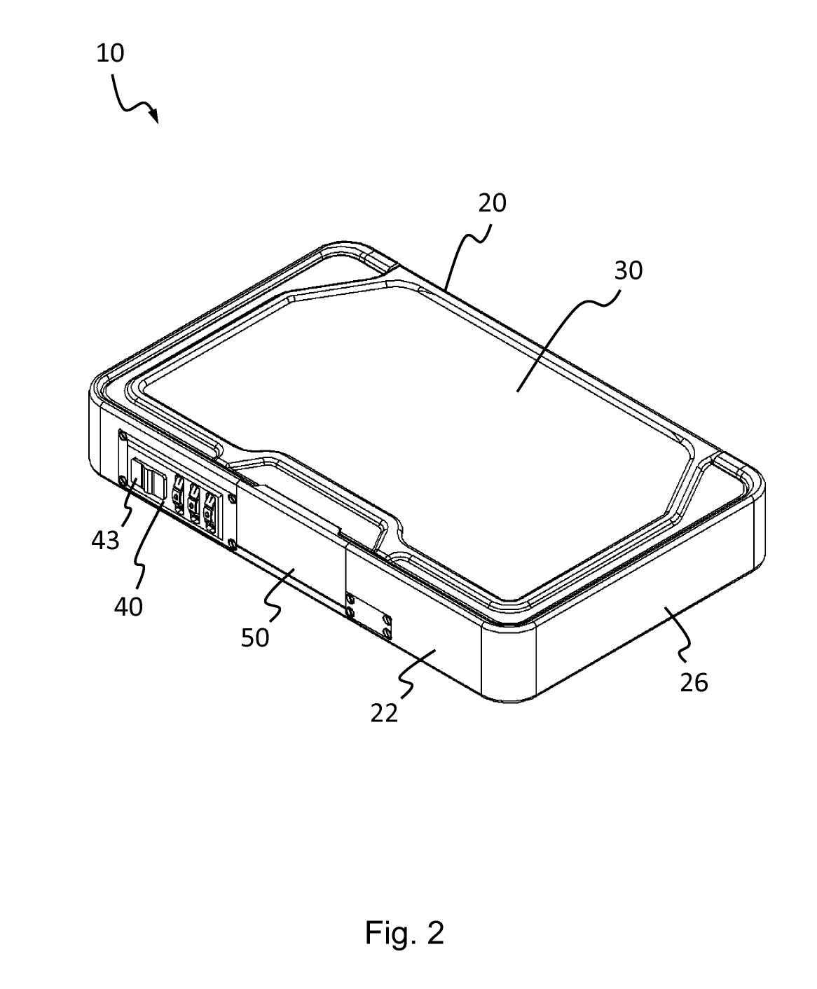

Now referring to FIG. 2, a perspective view of the secure shell 10 in a closed state is shown. The locking mechanism 40 ensures latch 50 is fully engaged and cannot be released without the proper lock combination. When the latch 50 is engaged, it holds the lid 30 in place in a closed position until the latch 50 is unlocked.

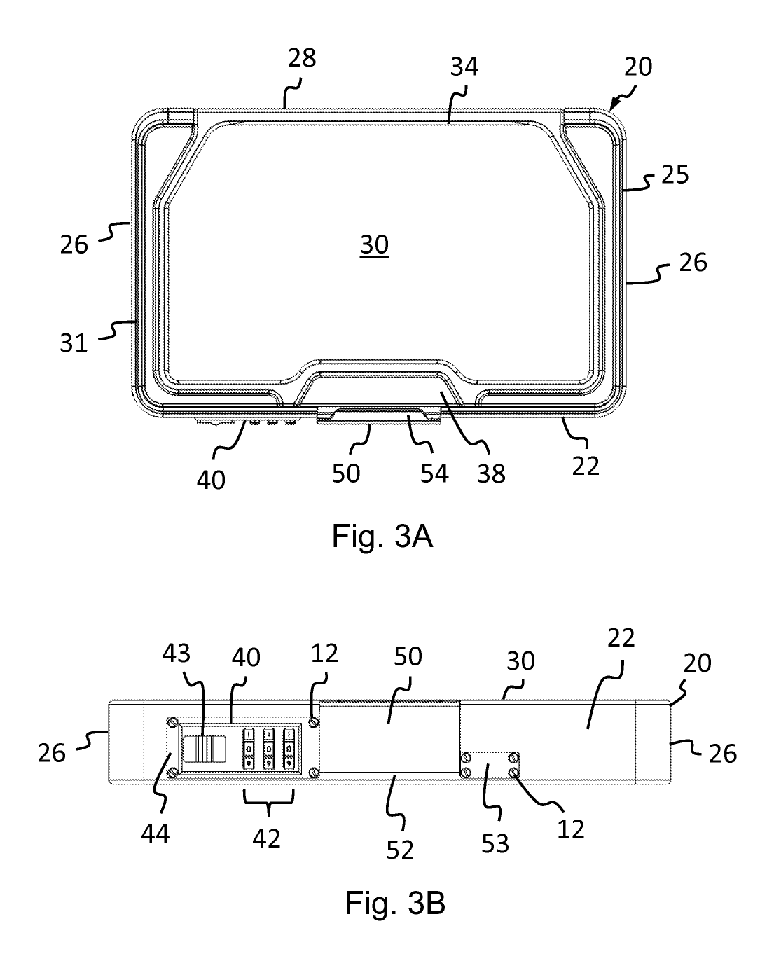

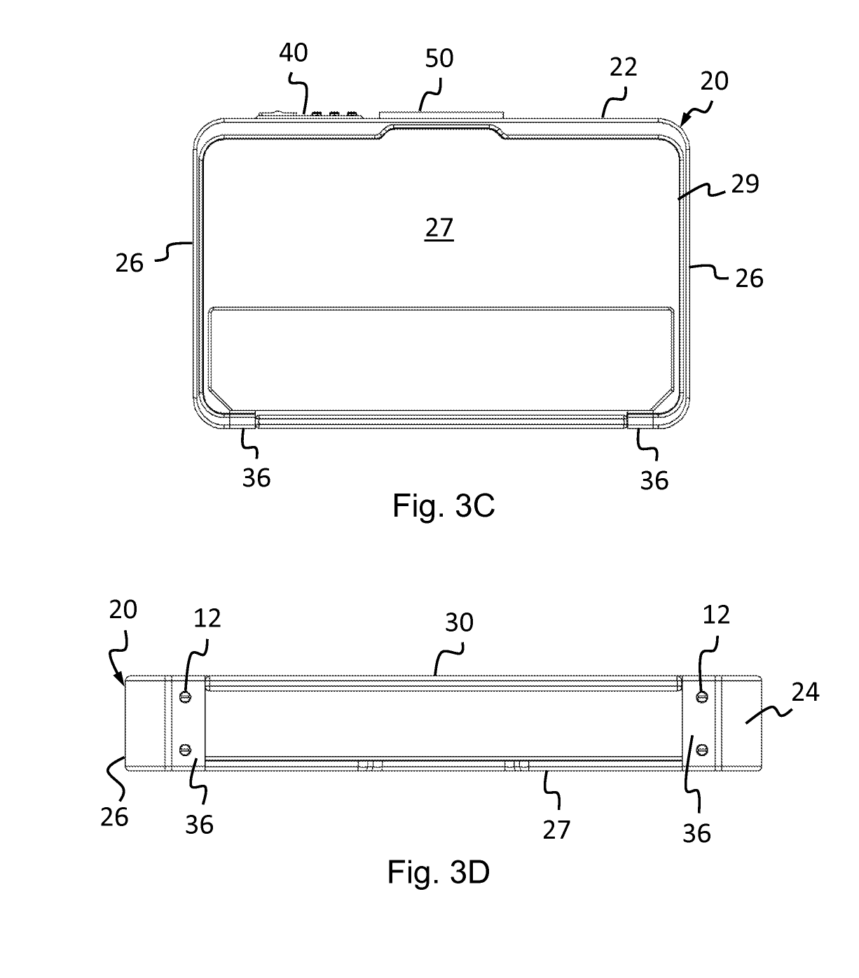

Now referring to FIGS. 3A through 3D, various views of the secure shell 10 are illustrated in greater detail. FIG. 3A is a top view of the secure shell 10; FIG. 3B is a front view of the secure shell 10. The locking mechanism 40 and latch 50 are accessible via the front face 22. Latch 50 is rotatably attached to the front face 22 via lower pivot shaft 52. The latch 50 includes a lip 54 at its upper extent for engaging with lid 30. Lid 30 includes a perimeter edge 31, a back edge 34, and a tongue 38.

The locking mechanism 40 is a combination lock having rotatable discs 42 and a sliding release button 43 to release the latch 50. Cover plate 53 provides access to internal components of the latch 50. The cover plate 53 is attached to front face 22 via four lock screws 12.

When the secure shell 10 is closed, the case 20 in conjunction with lid 30 provide a physical access barrier and electronic and radio frequency signal barrier. To ensure appropriate Faraday properties, the case 20 and lid 30 are made of appropriate conductive materials to provide the Faraday effect when the secure shell 10 is closed. Appropriate conductive materials include, among others, conductive metals such as nickel, copper, gold, silver, titanium and aluminum; conductive fibers impregnated with any of the conductive metals or carbon.

A Faraday cage, also known as a Faraday shield, is an enclosure that prevents external electromagnetic and radio frequency interference with any object placed inside the enclosure. A Faraday cage may be formed from a conductive material, a mesh of conductive material, a foundational mesh impregnated with conductive material, or a combination of these. The

Faraday cage construct ensures that electrical charges applied to the secure shell 10 remain on the exterior of the secure shell 10 and do not create an electric field within the interior cavity 23 of the secure shell 10.

In one version, the Faraday cage effect is produced by using appropriate conductive material to form the case 20 and lid 30. In another version, the Faraday cage is produced by embedding or layering a conductive mesh within or outside the case 20 and lid 30. The grid spacing of the mesh is such that it produces the effect of a Faraday cage and blocks all external electrical fields.

In another version, the case 20 and lid 30 are made of transparent material, such as plastic or glass, wherein a conductive mesh is sandwiched within the plastic or glass. In another configuration, the lid 30 is made from toughened glass, such as CORNING GORILLA GLASS, wherein the toughened glass has been modified to include a sandwiched conductive layer with contact points to provide a complete Faraday cage effect.

Where transparent material is used for the case 20 or lid 30, a user may visually confirm the contents of the secure shell 10 without opening the lid 30, thereby avoiding exposure of the device C to external electromagnetic signals.

Referring to FIG. 3B, in greater detail, the locking mechanism 40 is a combination lock having three rotatable discs 42. The locking mechanism 40 is integrated with the front face 22 of the case 20 using lock cover plate 44. The lock cover plate 44 is secured by four lock screws 12. The lock cover plate 44 covers the internal components (not shown) of the locking mechanism 40 to prevent tampering. The lock screws 12 are threaded into the case 20 using a locking substance applied to the screws 12 that ensures that the screws 12 may not be removed after assembly. The rotatable discs 42 are marked with a sequence of numbers or symbols. When the numbers or symbols on all discs 42 are rotated to the correct unlock position, the sliding release button 43 may be actuated and the locking mechanism 40 releases the latch 50 to open the lid 30.

In another version, (not shown herein) the locking mechanism 40 may include an electronic biometric lock, able to recognize certain unique physical characteristics of a user, such as a fingerprint, hand print, retina pattern, or voice. When there is a match between the data entered by the user and the stored data on the secure shell 10, the locking mechanism 40 releases the latch 50 to open the lid 30.

Now referring to FIG. 3C, a bottom view of the secure shell 10 and case 20 is shown. The case 20 includes a bottom face 27. Bottom face 27 includes a recess perimeter 29 circumscribing the bottom face 27. The recess perimeter 29 mates with the perimeter edge 31 of the lid 30 when the lid 30 is tucked underneath the bottom face 27 of the secure shell 10.

Now referring to FIG. 3D, the rear face 24 of the secure shell 10 is illustrated. Hinge pins 32 extend from back edge 30 of the lid 30 to rotatably and slidably engage in receptor channels 36. Receptor channels 36 are secured to the case 20 via multiple lock screws 12.

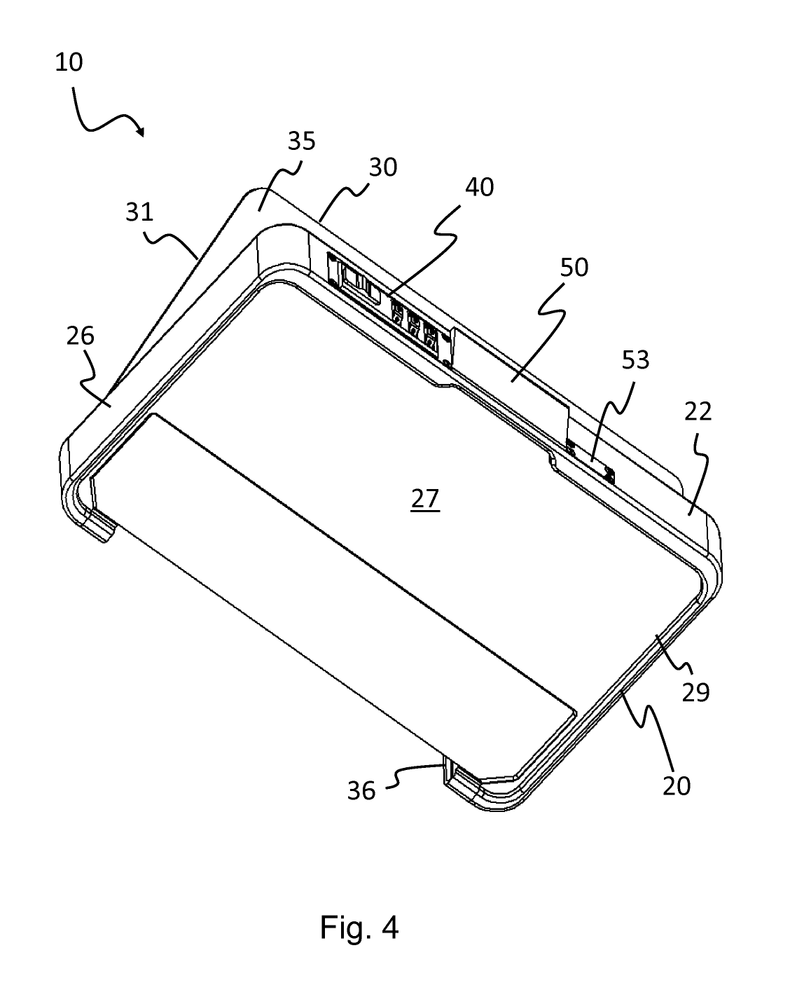

Referring to FIG. 4, a perspective view emphasizing the underside of the secure shell 10 is illustrated. The bottom face 27 of the case 20 is circumscribed by recess perimeter 29 which conforms to and mates with the perimeter edge 31 of the lid 30. Thus, when the lid 30 is moved to the bottom of the secure shell 10 via the receptor channels 36 and rotated underneath the bottom face 27 of the case 20, the lid 30 fits into the recess formed by the bottom face 27 and the recess perimeter 29. When lid 30 is stored adjacent the bottom face 27, an underside 35 of the lid 30 faces outward. The underside 35 may include various printed information regarding use and operation of the secure shell 10 to ensure that the secure shell 10 functions effectively.

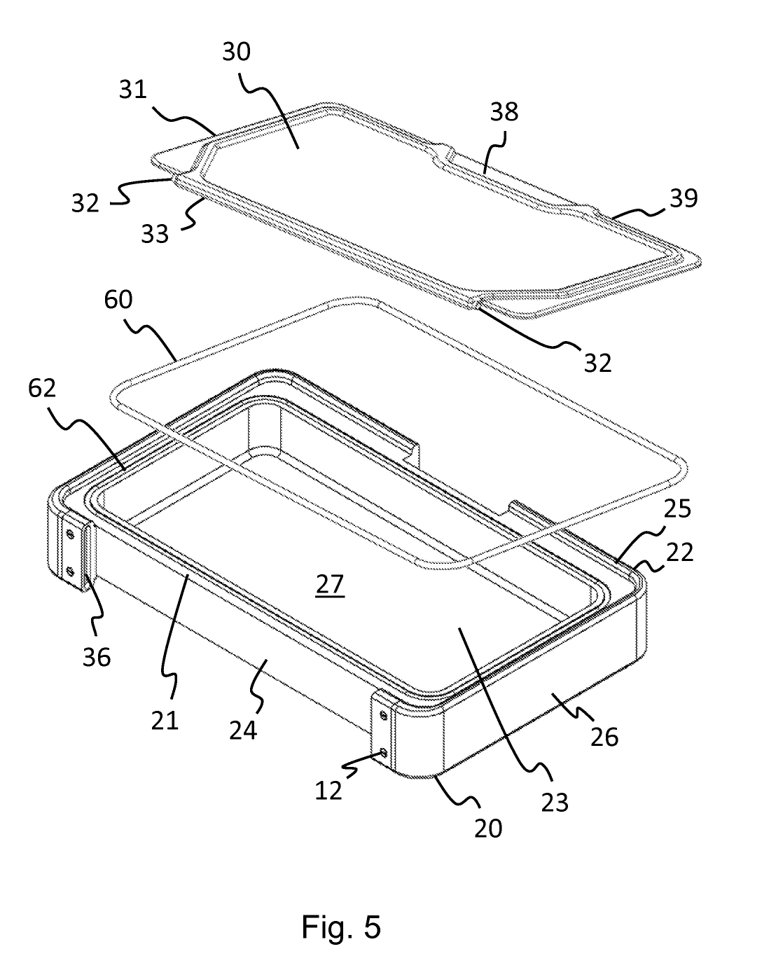

Now referring to FIG. 5, a partial exploded view of the secure shell 10 emphasizing a view from the rear face 24 of the case 20 is provided. Case 20 includes O-ring channel 62 for receiving O-ring 60. O-ring channel 62 circumscribes the perimeter of case 20 along an upper surface 21 of case 20. With O-ring 60 embedded in 0-ring channel 62, a compressible sealing surface is created. Thus, when the lid 30 is closed against the upper surface 21 of the case 20, a seal is created between the O-ring 60 and the underside 35 of the lid 30 to protect the device C from external environmental affects including fluids, dust and other potential contaminants.

Secure shell 10 is shaped as an essentially rectangular box wherein the case 20 is comprised of a front face 22, a rear face 24, and two sides 26, all of which extend vertically from the bottom face 27 to form an interior cavity 23. The interior cavity 23 is bounded about its perimeter by an upper surface 21 having an outer perimeter edge 25. The interior cavity 23 is sized to receive and engulf a device C. In other embodiments, the secure shell 10 may be shaped and sized differently to fit various other types of devices.

Lid 30 is sized to fit within the outer perimeter edge 25 of the upper surface 21 when the secure shell 10 is closed. Lid 30 includes hinge pins 32 that extend from a rear edge 33 to be slidably and rotatably received in receptor channels 36. Receptor channels 36 are secured to the case 20 using lock screws 12. Lid 30 includes a tongue 38 located at a front edge 39 of the lid 30 for locking engagement with a lip 54 of the latch 50.

With the lid 30 open, hinge pins 32 engaged within the receptor channels 36 allow the back edge 33 of the lid 30 to slide down adjacent the bottom face 27 of the secure shell 10. The receptor channels 36 are secured to the rear face 24 of the case 20 by lock screws 12. The lock screws 12 used throughout the case 20 are preferably threadably engaged along with the application of a film that prevents the lock screws 12 from being removed once the case 20 is assembled.

When the lid 30 is moved fully through the receptor channels 36, the lid 30 is rotatable on the hinge pins 32 such that the lid 30 may be swung about and under the bottom face 27 to be tucked away against the bottom face 27, thereby providing access to the interior cavity 23 of the secure shell 10.

When the lid 30 is in a closed position, the lid 30 compresses the O-ring gasket 60 to create a tight seal while the under face 35 of the lid 30 creates a conductive contact with upper surface 21 of the case 20, thus enabling the Faraday cage properties. In various configurations, the under face 35 of the lid 30 can include a contact ridge whose height is lower than the extended height of the O-ring gasket 60 before compression during closing. Thus, the O-ring gasket 60 is compressed until the contact ridge touches the outer perimeter edge 25. To ensure adequate sealing and sufficient surface contact, proper tolerance is required between the tongue 38 of the lid 30 and the lip 54 of the latch 50 when closed.

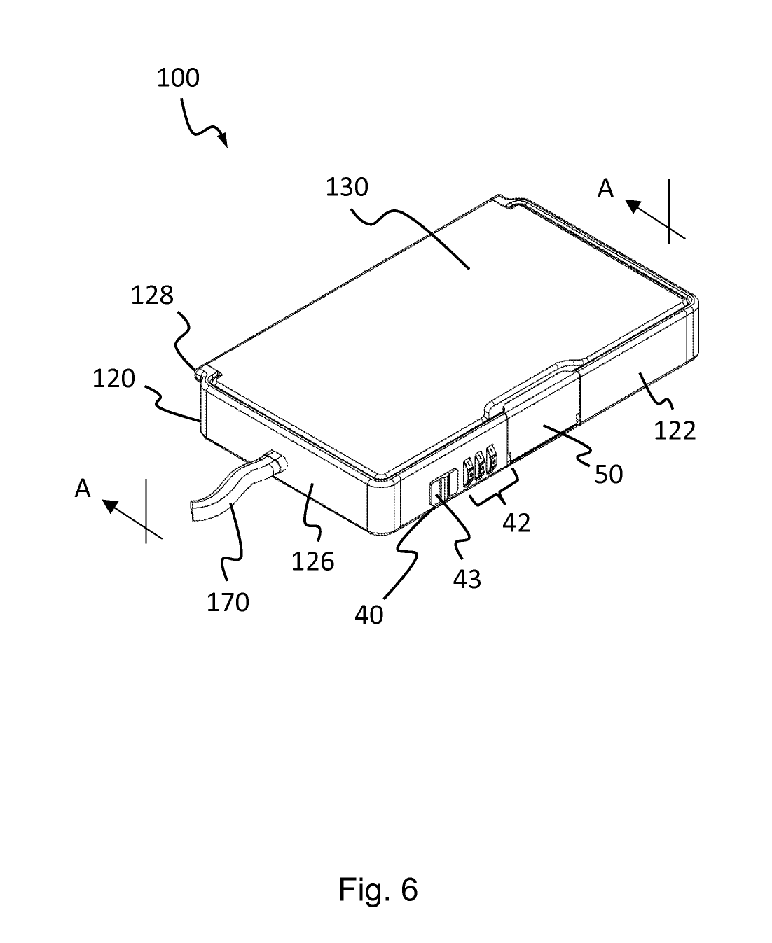

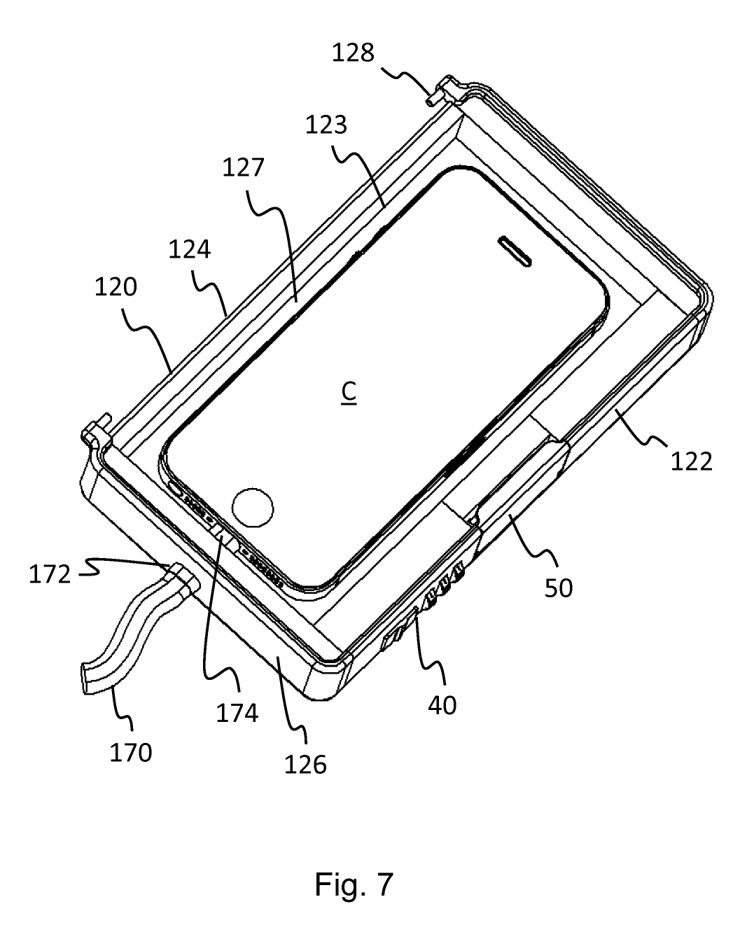

Now referring to FIG. 6, a perspective view of an alternative embodiment of the apparatus in a closed position is illustrated. Those items that are changed from the description in the first embodiment, secure shell 10, are identified by numbering in the 100s. In this embodiment, secure shell 100 supports charging of device C while enclosed in the secure shell 100. The lid 130 is rotatably engaged with the case 120 via case hinge pins 128. The locking mechanism 40 and latch 50 are consistent with descriptions in the first embodiment of the secure shell 10.

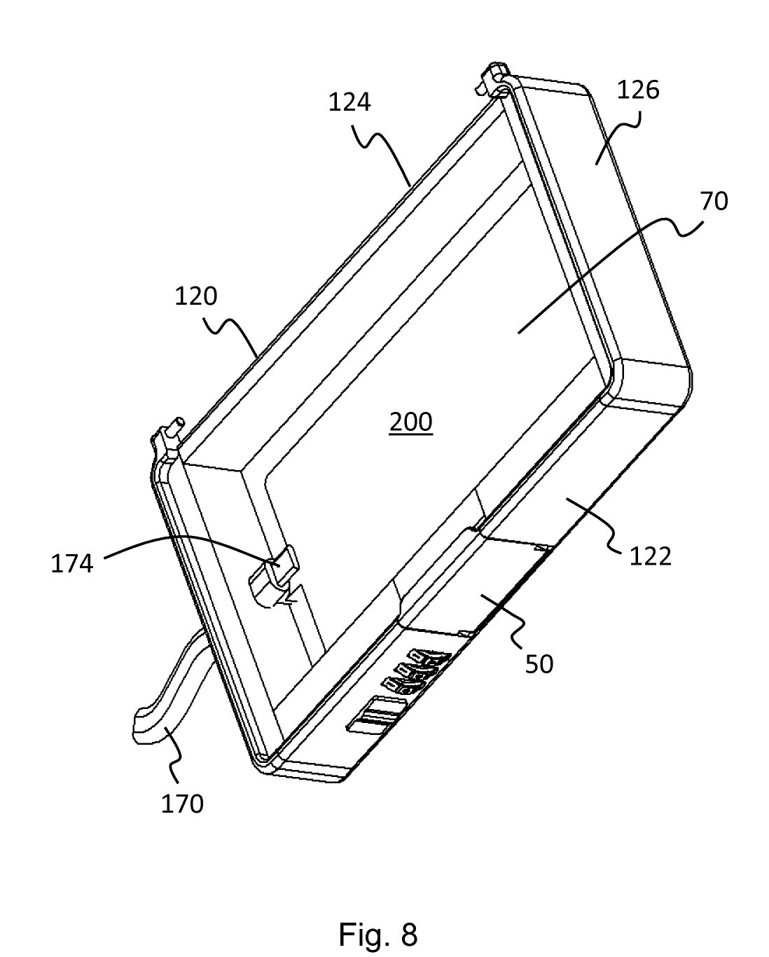

Now referring to FIG. 7, a perspective view of the secure shell 100 is shown with the lid 130 removed to illustrate placement of a device C within a cavity 123 of the secure shell 100. The case 120 is comprised of a front face 122, a rear face 124, and two side faces 126 all of which extend vertically from a bottom face 127 to form an interior cavity 123. A power cord 170 penetrates a side face 126 of the case 120. Secure shell 100 includes means for charging a device C while enclosed within the secure shell 100, whether open or closed. In one version, power is supplied to the secure shell 100 for charging a device by power cord 170. Cord 170 passes through a signal-resistant port 172 which penetrates a side face 126 of the case 120. The signal resistant port 172 is configured such that power passes through the power cord 170 to charge the device C, while external electromagnetic and radiofrequency signals are blocked when the secure shell 100 is closed.

Referring now to FIG. 8, a perspective view of the case 120 without device C is provided. With the device C removed from the case 120, the internal device power connector 174 is illustrated. In this example, the power connector 174 is of the type used by the most recent version of the APPLE IPHONE, known as a “LIGHTNING” connector. The LIGHTNING connector supports certain versions of products produced by APPLE including the IPHONE 5, IPHONE 5S, IPHONE 5C, IPOD TOUCH, IPOD NANO, IPAD, and IPAD MINI. The secure shell 100 is capable of adaption to support power connectors 174 for a plurality of electronic devices. The apparatus is modifiable to support electronic devices of many models with differences in size and power adaptors. The internal power connector 174 can be any of a USB connector, mini-USB connector, dock connector, or other type of connector matched to the device C with secure shell 100.

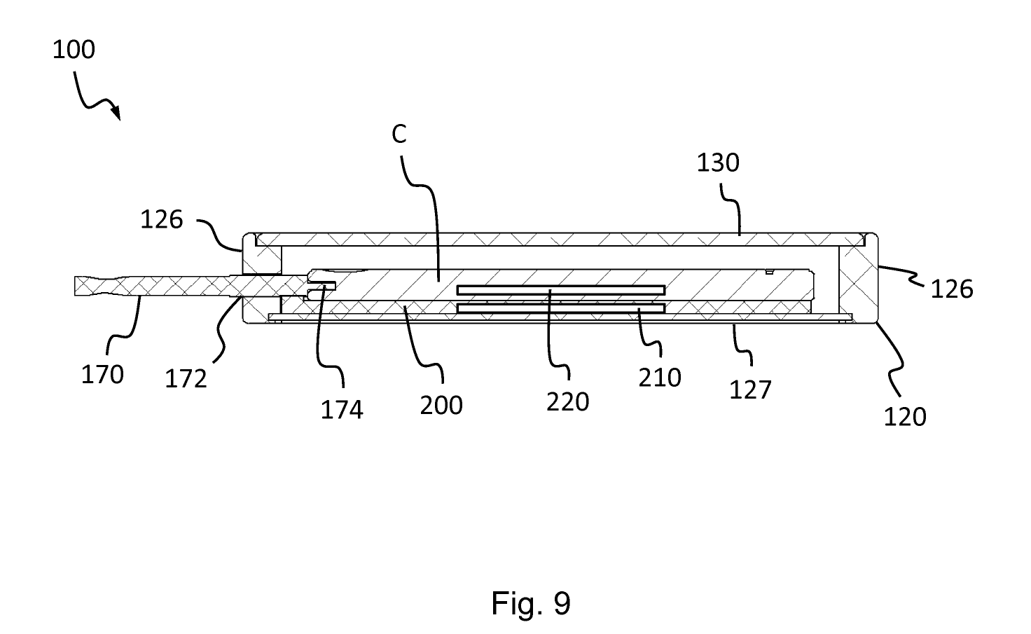

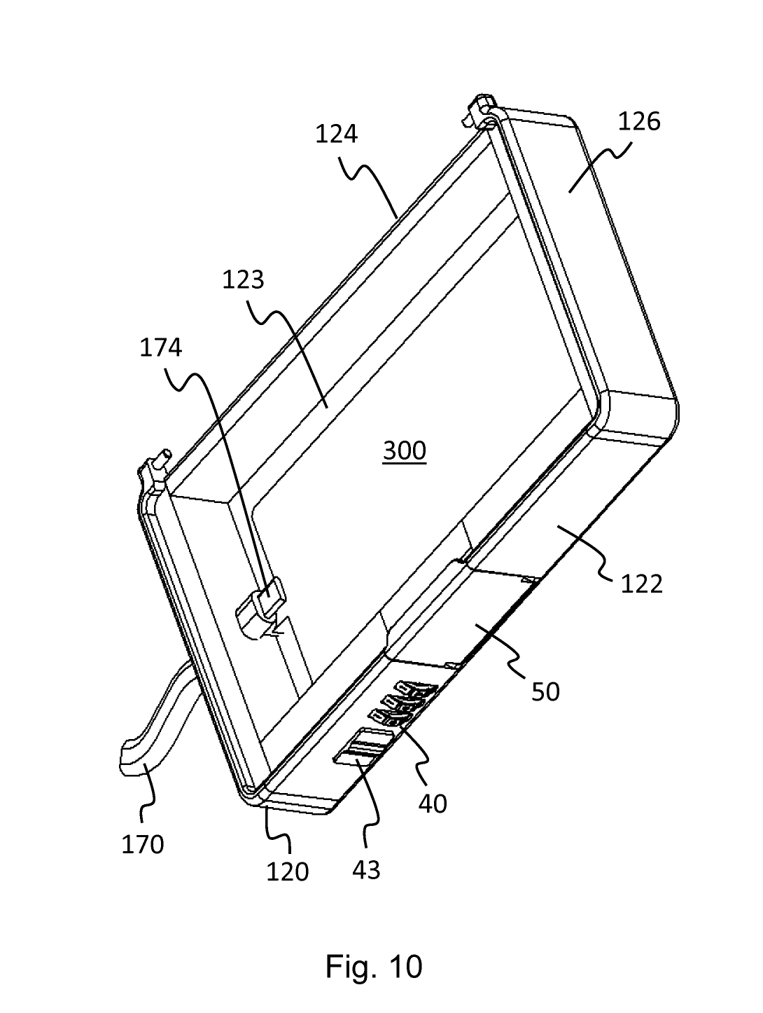

Referring now to FIG. 9, a cross-sectional view of the secure shell 100 shown in FIG. 6 along the cutting plane A-A is shown. Device C is enclosed inside the secure shell 100 in a closed and locked configuration. The closed lid 130 completes the Faraday cage and blocks external electromagnetic and radio frequency signals including cellular and data signals. The device C is plugged into the internal power connector 174. Inductive charging mat 200 is shown adjacent to the device C and the bottom face 127 of the case 120.

Now, still referring to FIG. 9, inductive charging means is provided to charge device C, eliminating the need for a physical power connector. Inductive charging is well-known technology but the inventor is unaware of any implementation of an inductive charging capability within the confines of a Faraday cage as described herein. In this version, inductive charging means includes an inductive charging mat 200 having a primary coil 210. The charging mat 210 is placed within the case 120 underneath the device C. The primary coil 210 creates an electromagnetic field to inductively transfer energy to a separate receiver coil 220 connected to power the battery of the device C. An external power supply is similarly connected to the inductive charging mat 200 via power cord 170.

In another version, not shown herein, a supplemental battery is placed inside the shell 10 to extend the battery life of the device C while enclosed in the secure shell 100. In one version, the supplemental battery is placed in the same location as the inductive charging mat 200. The supplemental battery delivers its power to the device C via the same power connector 174 used to provide external power via the power cord 170.

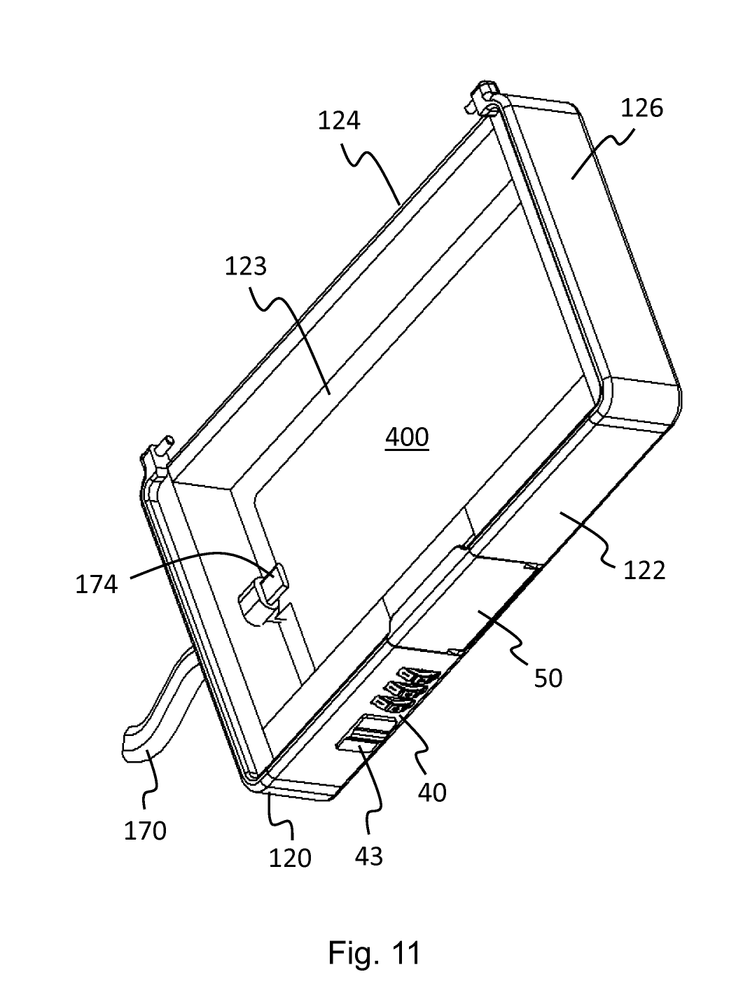

Now, means for dissipating heat from the secure shell 100 and enclosed device C is described. In one version, shown in FIG. 10, heat dissipation is accomplished via inclusion of a phase change pad 300 within the case 120. A substance with a high heat of fusion capable of absorbing large amount of heat is contained inside the pad 300 in solid form and changes to liquid or gel without raising its own temperature when the pad 300 absorbs heat from the device C.

In another version, shown in FIG. 11, heat dissipation is accomplished using conductive heat transfer. A thermal conductive layer 400 comprises one or more materials with high thermal conductivity. The conductive layer 400 rests adjacent the device C and transfers heat away from the device C. The conductive layer 400 is configured to conductively transfer heat to the case 120 where various cooling configurations may be used including external heat transfer fins and other heat transfer schemas. Conductive heat transfer can be further supplemented by placing the secure shell 100 in a location supported by a separate fan that causes convective transfer of the heat away from the secure shell 100.

In other versions, both a phase change layer 300 and a conductive heat transfer layer 400 may be used in combination to enhance cooling of the secure shell 100 and its enclosed device C.

The present invention has been particularly shown and described with respect to certain preferred embodiments and features thereof. However, it should be readily apparent to those of ordinary skill in the art that various changes and modifications in form and detail may be made without departing from the spirit and scope of the inventions as set forth in the appended claims. The inventions illustratively disclosed herein may be practiced without any element which is not specifically disclosed herein.

We claim:

1. A secure shell for electronic devices, comprising:
a. a case sized to receive and enclose an electronic device;
b. a lid;
c. a locking mechanism;
d. a latch;
e. a sealing O-ring; and
f. wherein the secure shell prevents electromagnetic signals from entering or leaving the secure shell when the lid is in a closed and latched position.

2. The secure shell of claim 1, wherein said electronic device is a cell phone.

3. The secure shell of claim 1, wherein said electromagnetic signals are cellular signals.

4. The secure shell of claim 1, further comprising an integral charging system.

5. The secure shell of claim 1, wherein said integral charging system comprises an inductive charging mat having a primary coil for transferring energy to a receiver coil connected to power a battery of said electronic device.

6. The secure shell of claim 1, further including a supplemental battery.

7. The secure shell of claim 1, further comprising means for dissipating heat from the secure shell and said enclosed electronic device.

8. The secure shell of claim 7, wherein said means for dissipating heat comprises a phase change pad.

9. The secure shell of claim 7, wherein said means for dissipating heat comprises a thermal conductive layer for transferring heat outside the secure shell from said electronic device.

10. The secure shell of claim 7, wherein said means for dissipating heat comprises a phase change pad and a thermal conductive layer.

11. The secure shell of claim 1, further comprising a conductive mesh layered within said case and said lid.

12. The secure shell of claim 11, wherein the said case and said lid are made of transparent material.

13. The secure shell of claim 12, wherein said transparent material is any of plastic and glass.
